(19) United States
(12) Patent Application Publication
(10) Pub. No.: US 2022/0149687 A1
(43) Pub. Date: May 12, 2022

(54) STATOR

(71) Applicant: TOYOTA JIDOSHA KABUSHIKI KAISHA, Toyota-shi (JP)

(72) Inventors: Kohei WATANABE, Okazaki-shi (JP); Masashi MATSUMOTO, Nagoya-shi (JP); Hazuki KAWAMURA, Nisshin-shi (JP)

(73) Assignee: TOYOTA JIDOSHA KABUSHIKI KAISHA, Toyota-shi (JP)

(21) Appl. No.: 17/454,113

(22) Filed: Nov. 9, 2021

(30) Foreign Application Priority Data
Nov. 9, 2020 (JP) 2020-186336

(51) Int. Cl. H02K 3/28

(52) U.S. Cl. CPC H02K 3/28

(57) ABSTRACT

A stator includes a stator core and a coil. The coil has a first segment coil, a second segment coil having a wire diameter greater than a wire diameter of the first segment coil, and a crossover wire connecting the first segment coil and the second segment coil. The first segment coil is disposed in a slot radially innermost to the stator core. At least one second segment coil is disposed in the slot. The crossover wire has a changeover portion at which a wire diameter of the crossover wire changes from a wire diameter of the first segment coil to a wire diameter of the second segment coil.

This nonprovisional application is based on Japanese Patent Application No. 2020-186336 filed on Nov. 9, 2020 with the Japan Patent Office, the entire content of which is hereby incorporated by reference.

### BACKGROUND

### Field

The present disclosure relates to a stator.

### Description of the Background Art

For example, Japanese Patent Laying-Open No. 2009-81980 discloses a stator comprising a stator core having multiple slots, and a coil segment mounted onto each slot.

### SUMMARY

When a motor, comprising a stator as disclosed in Japanese Patent Laying-Open No. 2009-81980, is being driven, the magnetic flux passes across the coil, thereby causing eddy current loss to occur. This loss is greater when the coil, passed across by the magnetic flux, has a larger cross-sectional. In particular, a portion of the coil in a slot, which portion being radially innermost to the stator core, has a high magnetic flux density. Thus, that portion has an increased eddy current loss.

An object of the present disclosure is to provide a stator which can reduce the eddy current loss that is caused at the coil when a motor is being driven.

A stator according to one aspect of the present disclosure includes: a stator core having a plurality of slots disposed spaced apart from one another in a circumference direction of the stator core; and a coil attached to the stator core, wherein the coil has: a first segment coil; a second segment coil electrically connected to the first segment coil and having a wire diameter greater than a wire diameter of the first segment coil; and a crossover wire connecting the first segment coil and the second segment coil outside of a slot in an axial direction of the stator core, wherein the first segment coil is disposed in the slot radially innermost to the stator core, at least one second segment coil is disposed in the slot, and the crossover wire has a changeover portion at which a wire diameter of the crossover wire changes from a wire diameter of the first segment coil to a wire diameter of the second segment coil.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a stator according to one embodiment of the present disclosure.

FIG. 2 is a diagram schematically showing a configuration of a coil.

FIG. 3 is a perspective view of a crossover wire.

FIG. 4 illustrates an example schematic of the coil.

FIG. 5 is a diagram schematically showing example arrangement of coils within a slot.

FIG. 6 is a diagram schematically showing example arrangement of coils within a slot, according to Comparative Example.

FIG. 7 is a perspective view of a variation of the crossover wire.

FIG. 8 is a plan view of the crossover wire of FIG. 7.

FIG. 9 is a perspective view of a variation of the crossover wire.

FIG. 10 is a plan view of the crossover wire of FIG. 9.

FIG. 11 is a perspective view of a variation of the crossover wire.

FIG. 12 is a plan view of the crossover wire of FIG. 11.

### DESCRIPTION OF THE PREFERRED EMBODIMENTS

An embodiment according to the present disclosure will be described, with reference to the accompanying drawings. Note that the same number is appended to the same or equivalent members in the drawings referred to in the following.

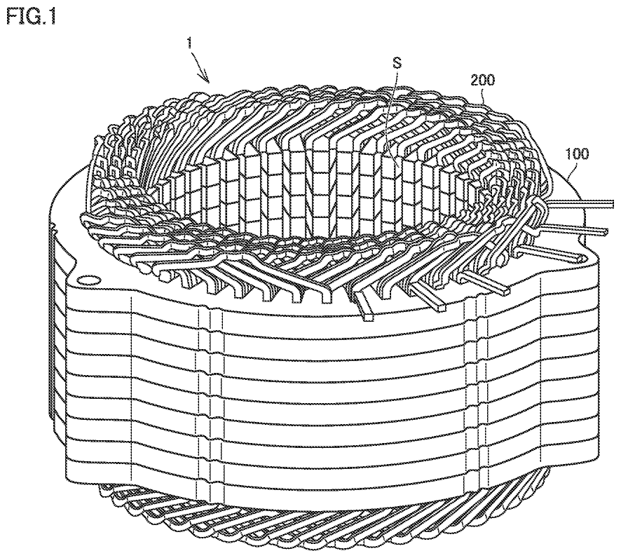

FIG. 1 is a perspective view schematically showing a stator according to one embodiment of the present disclosure. The stator 1 and a rotor (not shown) constitute a motor. For example, the motor is preferably applied as a three-phase AC generator to a battery electric vehicle, etc.

The stator 1 includes a stator core 100 and a coil 200.

The stator core 100 is made of iron. The stator core 100 is formed in a cylinder shape. The stator core 100 has multiple slots S disposed spaced apart from one another in the circumference direction of the stator core 100. Each slot S has a shape extending radially and axially of the stator core 100. In the present embodiment, the stator core 100 include 48 slots S.

The coil 200 is attached to the stator core 100. The coil 200 is made of copper. The coil 200 has a U-phase coil, a V-phase coil, and a W-phase coil. The coil 200 is wound around the stator core 100 in a distributed winding form.

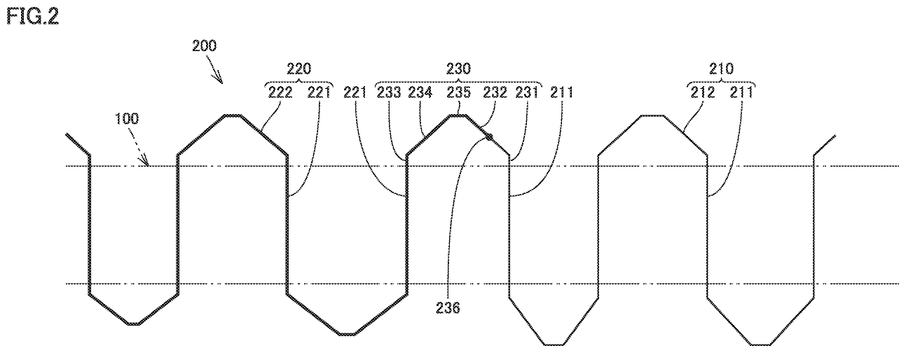

As shown in FIG. 2, the coil 200 has a first segment coil 210, a second segment coil 220, and a crossover wire 230.

The first segment coil 210 is formed of a flat wire. The first segment coil 210 has a first leg 211 and a first connection 212.

The first leg 211 is accommodated within a slot S. The first leg 211 has a shape extending linearly along the axial direction of the stator core 100.

The first connection 212 couples adjacent first legs 211 end to end. The first connection 212 is disposed outside of the stator core 100 in the axial direction.

The second segment coil 220 is formed of a flat wire. The second segment coil 220 is electrically connected to the first segment coil 210. The second segment coil 220 has a wire diameter greater than the wire diameter of the first segment coil 210. Note that the second segment coil 220 is indicated by a thicker line than the first segment coil 210 in FIG. 2.

The second segment coil 220 has the same configuration as the first segment coil 210, except for having a wire diameter greater than the wire diameter of the first segment coil 210. For this reason, the description of the second segment coil 220 will be simplified. The second segment coil 220 has a second leg 221 accommodated within a slot S, and a second connection 222 coupling adjacent second legs 221 end to end.

Outside of the slot S in the axial direction of the stator core 100, the crossover wire 230 connects the first segment coil 210 and the second segment coil 220. The crossover wire 230 has a first connecting end portion 231, a first inclined portion 232, a second connecting end portion 233, a second inclined portion 234, a turn portion 235, and a changeover portion 236.

The first connecting end portion 231 is connected to the first leg 211 of the first segment coil 210. The first connecting end portion 231 has a shape axially projecting from the stator core 100, starting from an end of the first leg 211.

The first inclined portion 232 is connected to the first connecting end portion 231. In other words, the first inclined portion 232 is electrically connected to the first leg 211. The first inclined portion 232 is inclined relative to the axial direction of the stator core 100.

The second connecting end portion 233 is connected to the second leg 221 of the second segment coil 220. The second connecting end portion 233 has a shape axially projecting from the stator core 100, starting from an end of the second leg 221.

The second inclined portion 234 is connected to the second connecting end portion 233. In other words, the second inclined portion 234 is electrically connected to the second leg 221. The second inclined portion 234 is inclined relative to the axial direction of the stator core 100.

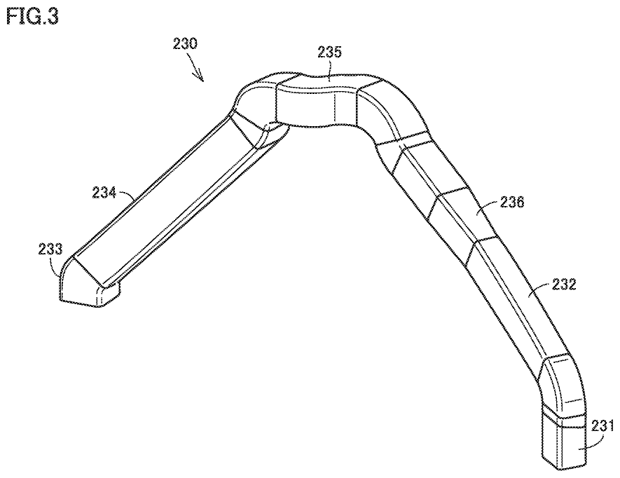

The turn portion 235 couples the first inclined portion 232 and the second inclined portion 234. More specifically, the turn portion 235 couples an end (the upper side in FIG. 3) of the first inclined portion 232 opposite the first connecting end portion 231 and an end (the upper side in FIG. 3) of the second inclined portion 234 opposite the second connecting end portion 233.

The changeover portion 236 is a portion of the coil 200 whose wire diameter changes from the wire diameter of the first segment coil 210 to the wire diameter of the second segment coil 220. In the present embodiment, the changeover portion 236 is provided at the first inclined portion 232, as shown in FIG. 3. The changeover portion 236 may be formed in a shape gradually changing in wire diameter from the wire diameter of the first segment coil 210 to the wire diameter of the second segment coil 220. The changeover portion 236 may also be formed of a step where the wire diameter changes from the wire diameter of the first segment coil 210 to the wire diameter of the second segment coil 220.

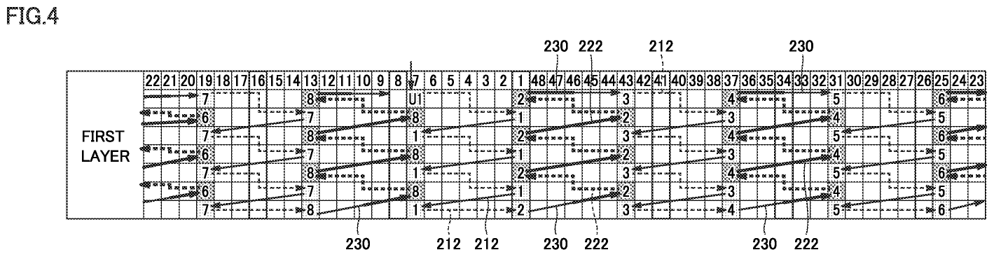

FIG. 4 illustrates an example schematic of the coil 200. Note that FIG. 4 shows the numbers “1” to “48” given to the slots S, the lighter dotted pattern indicating the first segment coil 210 disposed in each slot S being shown, and the darker dotted pattern indicating the second segment coil 220 disposed in each slot S. In addition, the solid lines indicate the connections 212, 222 located above the stator core 100, and the dashed lines indicate the connections 212, 222 located below the stator core 100.

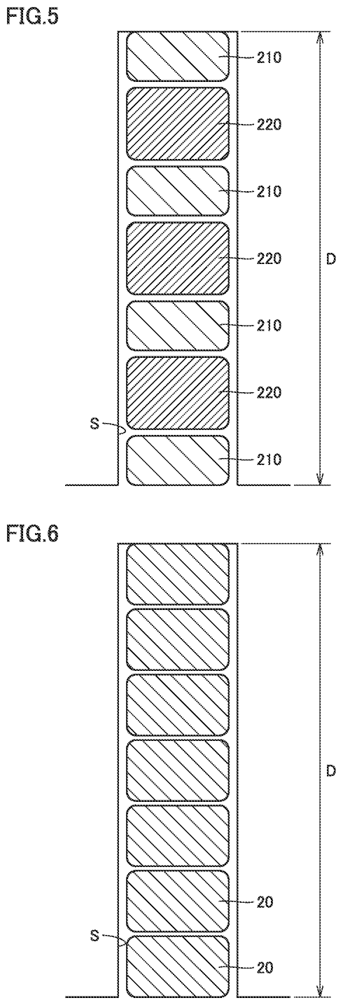

As shown in FIGS. 4 and 5, in the present embodiment, seven coils 200 (the first leg 211 and the second leg 221) are disposed in each slot S. The first leg 211 of the first segment coil 210 is disposed in the slot S radially innermost (the lower side in FIG. 5) to the stator core 100. At least one second segment coil 220 is disposed in each slot S.

As shown in FIGS. 4 and 5, preferably, the slot S includes a region in which the first segment coil 210 and the second segment coil 220 are alternately disposed in the listed order, starting from the radially inner side to the radially outer side to the stator core 100. However, the first segment coil 210 and the second segment coil 220 may not be alternately disposed in the listed order across a slot S, insofar as the first leg 211 of the first segment coil 210 is disposed in that slot S radially innermost to the stator core 100, and at least one second segment coil 220 is disposed in that slot S.

FIG. 6 schematically shows an example in which only a coil 20 according to Comparative Example is disposed within a slot S. The coil 20 according to Comparative Example has, for example, an intermediate wire diameter between the wire diameter of the first segment coil 210 and the wire diameter of the second segment coil 220. As shown in FIGS. 5 and 6, the first segment coil 210 and the second segment coil 220 can be disposed in a slot S that has the same depth D as a depth D of a slot S when only the coil 20 according to Comparative Example is disposed therein. In other words, the stator 1 having different turns can be designed, using the same stator core 100 as a conventional stator core in which only the coil 20 according to Comparative Example is disposed in a slot S. Owing to this, the stator 1 can accommodate a wide range of torque and a wide range of output power characteristics.

In the above-described stator 1 according to the present embodiment, since the first segment coil 210 is disposed in the slot S radially innermost to the stator core 100, eddy current loss can be reduced at that portion. Moreover, since at least one second segment coil 220 is disposed in each slot S, the cross-sectional area of the coil 200 is secured in each slot S, thereby securing an amount of current. Furthermore, since the changeover portion 236 is provided outside of the slot S in the axial direction of the stator core 100, the manufacturing and designing of the stator core 100 can be simplified, as compared to the case in which the changeover portion is provided within the slot S.

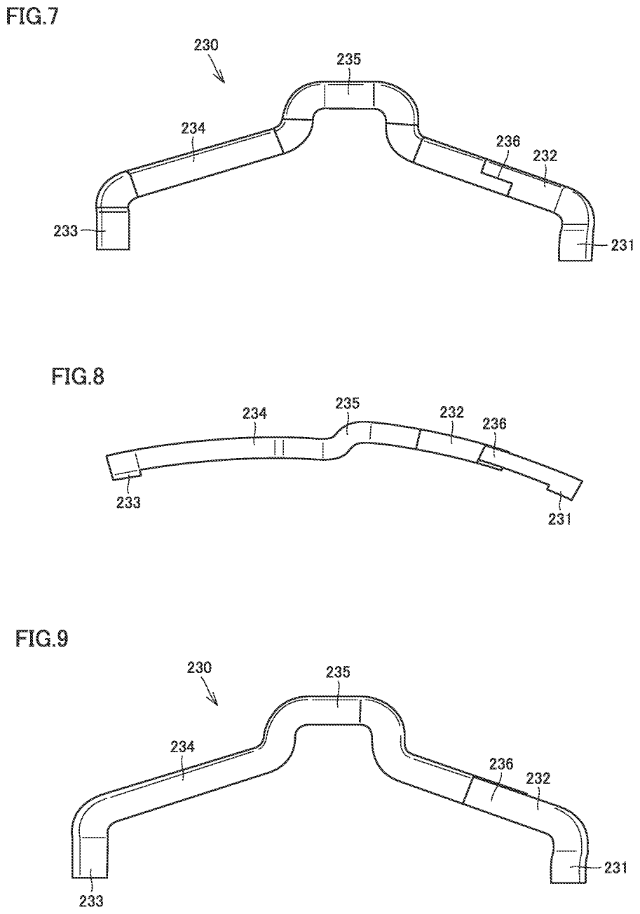

In the above embodiment, as shown in FIGS. 7 and 8, the changeover portion 236 may have a portion having a mating surface having the wire diameter of the first segment coil 210 and a portion having a mating surface having the wire diameter of the second segment coil 220, and the mating surfaces may face each other in the direction parallel to the axial direction of the stator core 100. Alternatively, the mating surfaces may face each other in the radial direction of the stator core 100, as shown in FIGS. 9 and 10.

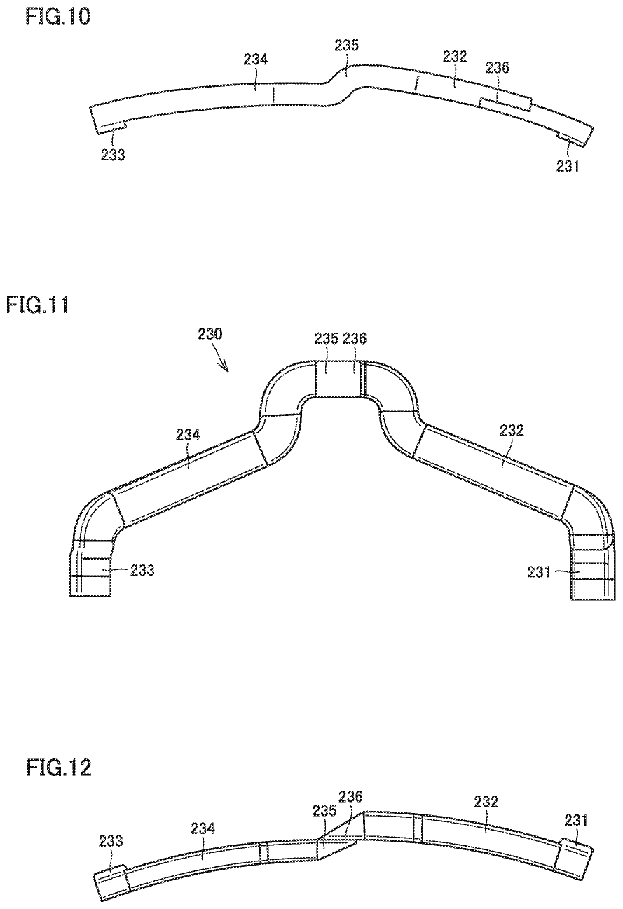

Moreover, the changeover portion 236 may be provided at the turn portion 235, as shown in FIGS. 11 and 12. Alternatively, although not shown, the changeover portion 236 may be provided at the first connecting end portion 231 or the second connecting end portion 233.

A person skilled in the art would understand that the example embodiment described above is a specific example of the following aspects.

The stator according to the above embodiment includes: a stator core having a plurality of slots disposed spaced apart from one another in a circumference direction of the stator core; and a coil attached to the stator core, wherein the coil has: a first segment coil; a second segment coil electrically connected to the first segment coil and having a wire diameter greater than a wire diameter of the first segment coil; and a crossover wire connecting the first segment coil and the second segment coil outside of a slot in an axial direction of the stator core, wherein the first segment coil is disposed in the slot radially innermost to the stator core, at least one second segment coil is disposed in the slot, and the crossover wire has a changeover portion at which a wire diameter of the crossover wire changes from a wire diameter of the first segment coil to a wire diameter of the second segment coil.

In this stator, since the first segment coil is disposed in the slot radially innermost to the stator core, eddy current loss can be reduced at that portion. Moreover, since at least one second segment coil is disposed in each slot, the cross-sectional area of the coil is secured in each slot, thereby securing an amount of current.

Preferably, the slot includes a region in which the first segment coil and the second segment coil are alternately disposed in the listed order in the slot, starting from a radially inner side to a radially outer side to the stator core.

Preferably, the first segment coil has a first leg disposed within the slot and having a shape extending along in the axial direction, the second segment coil has a second leg disposed within the slot and having a shape extending along the axial direction, and the crossover wire has: a first inclined portion electrically connected to the first leg, and inclined relative to the first leg, a second inclined portion electrically connected to the second leg, and inclined relative to the second leg, and a turn portion coupling the first inclined portion and the second inclined portion.

In this case, the changeover portion may be provided at the first inclined portion or the second inclined portion.

Alternatively, the changeover portion may be provided at the turn portion.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A stator, comprising:
a stator core having a plurality of slots disposed spaced apart from one another in a circumference direction of the stator core; and
a coil attached to the stator core, wherein
the coil has:
a first segment coil;
a second segment coil electrically connected to the first segment coil and having a wire diameter greater than a wire diameter of the first segment coil; and
a crossover wire connecting the first segment coil and the second segment coil outside of a slot in an axial direction of the stator core, wherein
the first segment coil is disposed in the slot radially innermost to the stator core,
at least one second segment coil is disposed in the slot, and
the crossover wire has a changeover portion at which a wire diameter of the crossover wire changes from a wire diameter of the first segment coil to a wire diameter of the second segment coil.

2. The stator according to claim 1, wherein
the slot includes a region in which the first segment coil and the second segment coil are alternately disposed in the listed order in the slot, starting from a radially inner side to a radially outer side to the stator core.

3. The stator according to claim 1, wherein
the first segment coil has a first leg disposed within the slot and having a shape extending along in the axial direction,
the second segment coil has a second leg disposed within the slot and having a shape extending along the axial direction, and
the crossover wire has:
a first inclined portion electrically connected to the first leg, and inclined relative to the first leg,
a second inclined portion electrically connected to the second leg, and inclined relative to the second leg, and
a turn portion coupling the first inclined portion and the second inclined portion.

4. The stator according to claim 3, wherein
the changeover portion is provided at the first inclined portion or the second inclined portion.

5. The stator according to claim 3, wherein
the changeover portion is provided at the turn portion.
